(19) United States
(12) Patent Application Publication
(10) Pub. No.: US 2014/0075020 A1
(43) Pub. Date: Mar. 13, 2014

(54) SERVER DEVICE, INFORMATION PROCESSING METHOD, AND COMPUTER PROGRAM PRODUCT

(71) Applicants: Masato TAKAHASHI, Tokyo (JP); Yohei Ando, Kanagawa (JP); Yuya Akimoto, Tokyo (JP)

(72) Inventors: Masato TAKAHASHI, Tokyo (JP); Yohei Ando, Kanagawa (JP); Yuya Akimoto, Tokyo (JP)

(21) Appl. No.: 14/020,002

(22) Filed: Sep. 6, 2013

(30) Foreign Application Priority Data
Sep. 10, 2012 (JP) 2012-198926

(51) Int. Cl. G06F 11/30

(52) U.S. Cl. CPC G06F 11/3062
USPC 709/224

(57) ABSTRACT

A storage unit of a server device stores first identification information on a power feeding device and stores a layout drawing. The layout drawing is a drawing in which a first image indicating the power feeding device is located at a first position that corresponds to the positional information in the real space. A receiving unit receives, from the power feeding device, first data that includes the first identification information on the power feeding device and second identification information on an information processing apparatus to which the power feeding device feeds the electric power. An update unit updates the layout drawing by locating a second image indicating the information processing apparatus identified by the received second identification information at a second position that is within a predetermined area of the first position of the power feeding device identified by the first identification information included in the first data.

### CROSS-REFERENCE TO RELATED APPLICATIONS

The present application claims priority to and incorporates by reference the entire contents of Japanese Patent Application No. 2012-198926 filed in Japan on Sep. 10, 2012.

### BACKGROUND OF THE INVENTION

1. Field of the Invention

The present invention relates to a server device, an information processing method, and a computer program product.

2. Description of the Related Art

There are systems known for determining the positions of network-connected information processing apparatuses. For example, Japanese National Publication of International Patent Application No. 2010-531022 discloses a method for determining the physical positions of network devices by detecting changes in the electric power of power distribution devices.

However, it is conventionally difficult to visually check the positions of various other network-connected information processing apparatuses, such as mobile terminals or image forming apparatuses, from remote locations in real time.

Therefore, it is desirable to provide a server device, an information processing method, and a computer program product by which it is possible to visually provide the positions of network-connected information processing apparatuses in real time.

### SUMMARY OF THE INVENTION

It is an object of the present invention to at least partially solve the problems in the conventional technology.

According to an aspect of the present invention, there is provided a server device including: a storage unit that stores first identification information on a power feeding device and that stores a layout drawing that has a first image located at a first position, the power feeding device being connected to the server device via a network and feeding electric power to an information processing apparatus that is connected to the server device via a network, the first image indicating the power feeding device that is identified by the first identification information, and the first position corresponding to positional information in a real space; a receiving unit that receives, from the power feeding device, first data that includes the first identification information on the power feeding device and that includes second identification information on the information processing apparatus that has its electric power fed by the power feeding device; an update unit that updates the layout drawing by locating a second image at a second position on the layout drawing, the second image indicating the information processing apparatus that is identified by the second identification information included in the received first data, and the second position being within a predetermined area of the first position of the power feeding device that is identified by the first identification information included in the first data, and a transmitting unit that transmits the layout drawing to the information processing apparatus at least when the layout drawing is updated.

According to another aspect of the present invention, there is provided an information processing method performed by a server device, the information processing method including: receiving, from a power feeding device, first data that includes first identification information on the power feeding device and that includes second identification information on an information processing apparatus that has its electric power fed by the power feeding device, the power feeding device being connected to the server device via a network and feeding electric power to the information processing apparatus that is connected to the server device via a network, updating a layout drawing that is stored in a storage unit, the storage unit storing, in a related manner, the first identification information and the layout drawing that has a first image located at a first position, the first image indicating the power feeding device that is identified by the first identification information, the first position corresponding to positional information in a real space, the layout drawing being updated by locating a second image at a second position on the layout drawing, the second image indicating the information processing apparatus that is identified by the second identification information included in the received first data, and the second position being within a predetermined area of the first position of the power feeding device that is identified by the first identification information included in the first data; and transmitting the layout drawing to the information processing apparatus at least when the layout drawing is updated.

According to another aspect of the present invention, there is provided a computer program product including a non-transitory computer-readable medium having computer readable program codes, performed by a server device, the program codes when executed causing the server device to execute: receiving, from a power feeding device, first data that includes first identification information on the power feeding device and that includes second identification information on an information processing apparatus that has its electric power fed by the power feeding device, the power feeding device being connected to the server device via a network and feeding electric power to the information processing apparatus that is connected to the server device via a network, updating a layout drawing that is stored in a storage unit, the storage unit storing, in a related manner, the first identification information and the layout drawing that has a first image located at a first position, the first image indicating the power feeding device that is identified by the first identification information, the first position corresponding to positional information in a real space, the layout drawing being updated by locating a second image at a second position on the layout drawing, the second image indicating the information processing apparatus that is identified by the second identification information included in the received first data, and the second position being within a predetermined area of the first position of the power feeding device that is identified by the first identification information included in the first data; and transmitting the layout drawing to the information processing apparatus at least when the layout drawing is updated.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an information processing system;

FIG. 2 is a system configuration diagram of the information processing system;

FIG. 3 is a schematic diagram that illustrates an example of the data structure of second data;

FIG. 4 is a schematic diagram that illustrates an example of the data structure of third data;

FIG. 5 is a flowchart that illustrates an example of the steps of the information processing performed by an information processing apparatus;

FIG. 6 is a flowchart that illustrates the steps of the information processing performed by a power feeding device;

FIG. 7 is a flowchart that illustrates the steps of the information processing performed by a server device;

FIG. 8 is a flowchart that illustrates the steps of an update process;

FIG. 9 is a flowchart that illustrates the steps of an update process;

FIG. 10 is a flowchart that illustrates the steps of a display process performed by the server device;

FIG. 11 is a schematic diagram that illustrates an example of a layout drawing;

FIG. 12 is a schematic diagram that illustrates an example of a layout drawing;

FIG. 13 is a schematic diagram that illustrates an example of a layout drawing;

FIG. 14 is a schematic diagram that illustrates an example of a layout drawing;

FIG. 15 is a schematic diagram that illustrates an example of a layout drawing;

FIG. 16 is a schematic diagram that illustrates an example of a layout drawing;

FIG. 17 is a schematic diagram that illustrates an example of a layout drawing; and

FIG. 18 is a schematic diagram that illustrates an example of a layout drawing.

### DETAILED DESCRIPTION OF THE PREFERRED EMBODIMENTS

An embodiment of a server device, an information processing method, and an information processing program is explained in detail below with reference to the accompanying drawings.

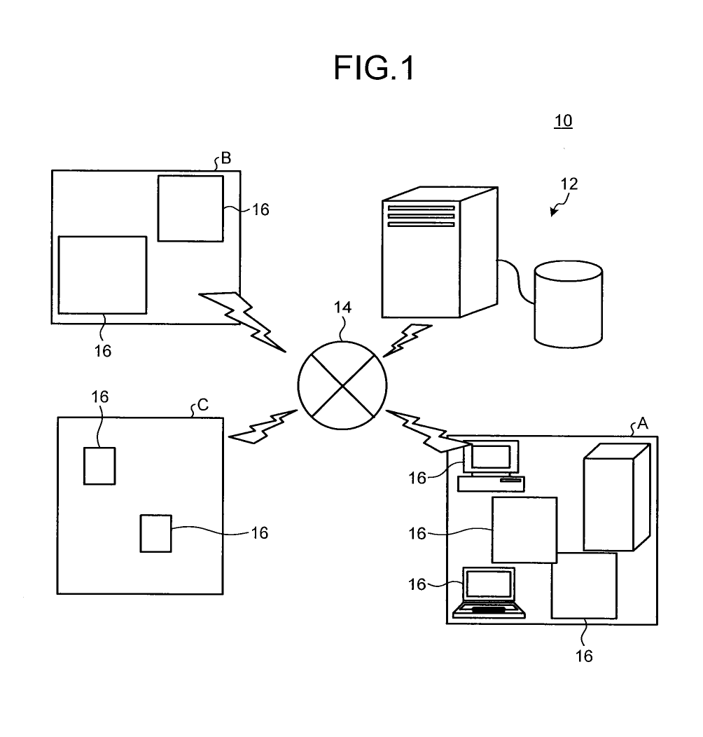

FIG. 1 is a schematic view of an information processing system 10 according to the present embodiment.

In the information processing system 10, a plurality of information processing apparatuses 16 is connected to a server device 12 via a network 14.

The network 14 is a known communication line. The network 14 may be a wired communication network or wireless communication network. The network 14 is, for example, the local area network (LAN) or the Internet.

The information processing apparatus 16 is an apparatus that performs various functions.

The information processing apparatus 16 is, for example, a personal computer (PC), mobile terminal (e.g., smart phone), image forming apparatus, image display apparatus, video-conference device, or the like. The image forming apparatus is an apparatus that has at least one of the printer function, the fax function, and the scanner function to form images. The image display apparatus is a known apparatus that displays images. The image display apparatus is, for example, a projector. The video-conference device is a known video-conference device. The video-conference device is a device that transmits/receives and outputs images and sounds to and from the information processing apparatus 16 via the network 14.

The information processing apparatuses 16 included in the information processing system 10 may be installed in the same location or may be installed in separate locations. In the present embodiment, an explanation is given of a case where the information processing apparatuses 16 included in the information processing system 10 are spread out such that one or more information processing apparatuses 16 are located in each of an area B of the shop, or the like, an area C of the user's house, or the like, and an area A of the user's office, or the like.

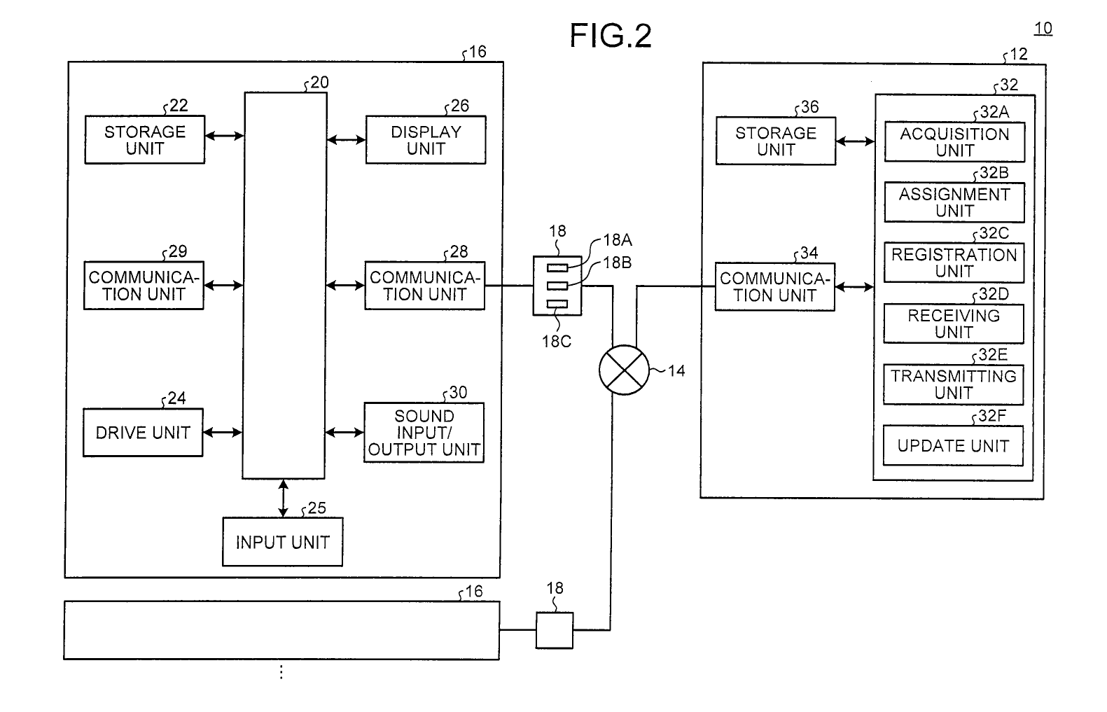

FIG. 2 is a system configuration diagram of the information processing system 10.

The information processing apparatus 16 includes a control unit 20, a storage unit 22, a communication unit 29, a drive unit 24, an input unit 25, a display unit 26, a communication unit 28, and a sound input/output unit 30.

The communication unit 28 is an interface that performs communication with the server device 12 via a power feeding device 18 and the network 14. The display unit 26 displays various types of information, such as a display screen. The display unit 26 is a known display device, such as a liquid crystal display (LCD).

The input unit 25 receives operation instructions, or the like, for various types of information, from users. The input unit 25 is, for example, a sound recognition device, such as a microphone, mouse, button, remote controller, keyboard, or the like. The input unit 25 and the display unit 26 may be integrally formed.

The sound input/output unit 30 inputs and outputs sound.

The storage unit 22 is a storage medium, such as a hard disk drive (HDD). The storage unit 22 stores various types of information. The communication unit 29 is an interface that performs short-range communication with another information processing apparatus 16 that is located near the information processing apparatus 16. A known device that performs short-range infrared communication is used as the communication unit 28.

The drive unit 24 drives a functional unit for each function that is executable in the information processing apparatus 16. For example, if the information processing apparatus 16 is an image forming apparatus, the drive unit 24 drives an image forming unit (not illustrated) that is installed in the information processing apparatus 16 and that forms images on a recording medium. If the information processing apparatus 16 is a display device, such as a projector, the control unit 20, instead of the drive unit 24, drives the display unit 26.

The control unit 20 is a computer that includes a central processing unit (CPU), a read only memory (ROM), a random access memory (RAM), or the like, and it performs overall control of the information processing apparatus 16.

The power feeding device 18 is connected to the server device 12 via the network 14. Furthermore, the power feeding device 18 is a device that feeds the electric power to the connected information processing apparatus 16. One or more information processing apparatuses 16 are connected to the single power feeding device 18. That is, the single power feeding device 18 is capable of supplying the electric power to the multiple information processing apparatuses 16. The power feeding device 18 and the information processing apparatus 16 are connected to each other via a known wired or wireless communication line. The communication line is, for example, a network; however, this is not a limitation.

In the present embodiment, the power feeding device 18 is a power feeding device that is capable of performing communication over the Internet by using a communication protocol, such as TCP/IP. The power feeding device 18 is an electric-power feeding outlet (in Japan, AC 100V) that is installed inside a room, or the like, or the power feeding device 18 that is capable of wirelessly transmitting the electric power. In the present embodiment, an explanation is given of a case where the power feeding device 18 that is capable of wirelessly transmitting the electric power is used; however, this is not a limitation.

According to the present embodiment, the power feeding device 18 is capable of feeding the electric power to one or more information processing apparatuses 16 that are located within a predetermined area (distance).

The power feeding device 18 is a computer that includes a central processing unit (CPU), a read only memory (ROM), a random access memory (RAM), or the like. The power feeding device 18 feeds the electric power to the connected information processing apparatus 16.

The power feeding device 18 includes a storage unit 18A, a control unit 18B, and a communication unit 18C.

The control unit 18B controls the power feeding device 18. The communication unit 18C is an interface that performs communication with the connected information processing apparatus 16 and the server device 12 that is connected via the network 14.

The communication unit 18C receives, from the information processing apparatus 16, second identification information on the information processing apparatus 16 to which the power feeding device 18 has started to feed the electric power. The control unit 18B stores, in the storage unit 18A, the second identification information on the information processing apparatus 16, the operation status of the information processing apparatus 16, and the first identification information on the power feeding device 18 such that they are related to one another.

The second identification information is the identification information for uniquely identifying the information processing apparatus 16. In the following explanation, the second identification information is sometimes referred to as the apparatus ID. The first identification information is the identification information for uniquely identifying the power feeding device 18. In the following explanation, the first identification information is sometimes referred to as the power feeding device ID.

As well as the second identification information on the information processing apparatus 16 to which the power feeding device 18 has started to feed the electric power, the communication unit 18C may receive, from the information processing apparatus 16, the information indicating the owner of the information processing apparatus 16, the information indicating the type of information processing apparatus 16, or the like. In such a case, the above information may be also stored in the storage unit 18A. The type of information processing apparatus 16 is the information that indicates the classification that is obtained by classifying the information processing apparatuses 16 based on its function in advance. The type of information processing apparatus 16 is, for example, a mobile terminal (smartphone), an image forming apparatus (multifunction peripheral (MFP)), or an image display device (projector); however, this is not a limitation.

The operation status is, for example, “during operation”, “during stoppage”, or the like. The “during operation” indicates the state where the electric power is being supplied to the information processing apparatus 16. The “during stoppage” indicates the state where the electric power is not supplied to the information processing apparatus 16. The operation status may further include other information. For example, the operation status may further include the information that indicates the amount of electric power that is supplied to the information processing apparatus 16, or the like.

The storage unit 18A is a storage medium, such as a hard disk drive (HDD), or the like. The storage unit 18A stores various types of information. In the present embodiment, the storage unit 18A stores first data. The first data is a table that stores, in a related manner, the power feeding device ID of the power feeding device 18, the apparatus ID (the second identification information) of the information processing apparatus 16 to which the power feeding device 18 feeds the electric power, the operation status of the information processing apparatus 16 to which the power feeding device 18 feeds the electric power, the type of information processing apparatus 16, and the owner of the information processing apparatus 16.

The power feeding device 18 transmits the first data to the server device 12 when a request is received from the server device 12, when the power feeding device 18 starts to feed the electric power to the new information processing apparatus 16, when the power feeding device 18 cancels the power supply, or the like.

The server device 12 includes a control unit 32, a communication unit 34, and a storage unit 36.

The communication unit 34 is an interface for performing communication between the information processing apparatus 16 and the server device 12 via the network 14.

The storage unit 36 is a storage medium, such as a hard disk drive (HDD). The storage unit 36 stores various types of information.

In the present embodiment, the storage unit 36 stores various types of information, such as a layout drawing, second data, and third data.

The layout drawing is the image data on a map, layout, or the like, that indicates each of one or more areas that are objects to be managed by the information processing system 10. By the information processing, which will be described later, the layout drawing is updated to the image data that includes a first image indicating the power feeding device 18, a second image indicating the information processing apparatus 16, or the like. The storage unit 36 stores the image data on a layout drawing, the layout drawing being related to the layout drawing identification information (hereafter, sometimes referred to as the layout drawing No.) for uniquely identifying the layout drawing.

The first image is the image that indicates the power feeding device 18. The icon, or the like, that represents the power feeding device 18 as a symbol by using a simple picture is used as the first image; however, this is not a limitation. The storage unit 36 previously stores the information that indicates the power feeding device 18 and the first image. The first image may be changed as appropriate in accordance with the user's operation instruction via an operating unit (not illustrated), the change instruction received from the information processing apparatus 16, or the like.

The second image is the image that indicates the information processing apparatus 16. The icon, or the like, that represents the information processing apparatus 16 as a symbol by using a simple picture based on its type is used as the second image; however, this is not a limitation. The storage unit 36 previously stores the information that indicates the information processing apparatus 16 (or the type of information processing apparatus 16) and the second image. The second image may be changed as appropriate in accordance with the user's operation instruction via the operating unit (not illustrated), the change instruction received from the information processing apparatus 16, or the like.

Specifically, the layout drawing is a drawing in which the first image of the power feeding device 18 is located at a first position that corresponds to the positional information in the real space and the second image of the information processing apparatus 16 is located at a second position that corresponds to the positional information in the real space.

The first position of the first image is designated in accordance with the user's operation instruction in the information processing apparatus 16 (a detailed explanation will be given later). Furthermore, the second position of the second image is designated during the process performed by the server device 12 to update the layout drawing, which will be described later.

The second data is a table that relates the power feeding device ID (the first identification information), the layout drawing identification information, the positional coordinates, and the name of the layout drawing.

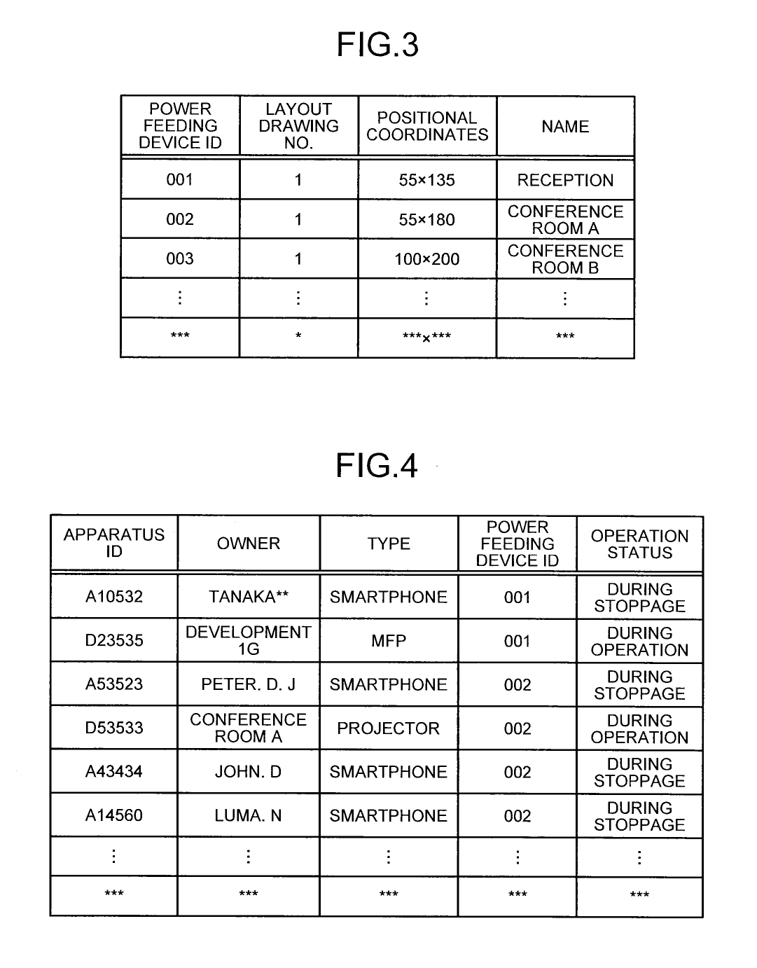

FIG. 3 is a schematic diagram that illustrates an example of the data structure of the second data. As illustrated in FIG. 3, the second data is a table that relates the power feeding device ID (the first identification information), the layout drawing identification information, the positional coordinates (the first position), and the name of the layout drawing.

FIG. 4 is a schematic diagram that illustrates an example of the data structure of the third data. As illustrated in FIG. 4, the third data is a table that relates the apparatus ID, the owner, the type, the power feeding device ID, and the operation status.

The apparatus ID is the second identification information. The owner is the owner of the information processing apparatus 16 that is identified by the corresponding apparatus ID. The type is the type of information processing apparatus 16 that is identified by the corresponding apparatus ID. The power feeding device ID is the first identification information on the power feeding device 18 that feeds the electric power to the information processing apparatus 16 that is identified by the corresponding apparatus ID. The operation status indicates the operation status of the information processing apparatus 16 that is identified by the corresponding apparatus ID.

The server device 12 stores, in the storage unit 36, the first data received from the power feeding device 18 so as to update the third data.

Specifically, by the information processing, which will be described later, the storage unit 36 stores, in a related manner, the image data on the layout drawing, the first image of the power feeding device 18 that is located at the first position on the layout drawing, the first position, the first identification information on the power feeding device 18, the second image of the information processing apparatus 16 that is located at the second position on the layout drawing, the second position, and the second identification information on the information processing apparatus 16.

With reference back to FIG. 2, the control unit 32 includes an acquisition unit 32A, an assignment unit 32B, a registration unit 32C, a receiving unit 32D, a transmitting unit 32E, and an update unit 32F.

The acquisition unit 32A acquires, from the information processing apparatus 16, the image data that is the original data on the layout drawing. The original data is the image data on the layout drawing that does not include the first image or the second image. The assignment unit 32B assigns the layout drawing identification information to the image data that is the original data received from the information processing apparatus 16. Furthermore, when the new power feeding device 18 is connected to the server device 12 via the network 14, the assignment unit 32B assigns the power feeding device ID (the first identification information) to the power feeding device 18. When the assignment unit 32B assigns a new power feeding device ID, the control unit 32 transmits the assigned power feeding device ID to the power feeding device 18 that is identified by the power feeding device ID. When receiving the power feeding device ID, the power feeding device 18 stores the power feeding device ID in the storage unit 18A. When various types of data are transmitted to the server device 12 next time, the data including the power feeding device ID is transmitted.

Furthermore, the assignment unit 32B assigns the address information that indicates the storage location of the layout drawing in the storage unit 36. For example, the assignment unit 32B assigns the Uniform Resource Locator (URL) as the address information that indicates the storage location of the layout drawing.

The registration unit 32C registers, in the storage unit 36, various types of data that are received from the information processing apparatus 16 or the power feeding device 18.

The receiving unit 32D receives, from the power feeding device 18, the above-described first data that includes at least the power feeding device ID (the first identification information) of the power feeding device 18 and the apparatus ID (the second identification information) of the information processing apparatus 16 to which the power feeding device 18 feeds the electric power.

The update unit 32F updates the layout drawing that is stored in the storage unit 36. Specifically, the update unit 32F locates, at a second position on the layout drawing, the second image of the information processing apparatus 16 that is identified by the apparatus ID (the second identification information) included in the received first data, the second position being within a predetermined area of the first position of the power feeding device 18 that is identified by the power feeding device ID (the first identification information) included in the received first data. Thus, the update unit 32F updates the layout drawing.

Next, an explanation is given of the steps of the information processing performed by each of the devices (the information processing apparatus 16, the power feeding device 18, and the server device 12) included in the information processing system 10.

In the present embodiment, the information processing apparatus 16 uses the browser software, or the like, to access the server device 12 from a remote location via the network 14, such as the Internet. Thus, the information processing apparatus 16 uses, as a form of service, the functions of various types of application software that are stored in the server device 12.

In the present embodiment, an explanation is given of a case where the information processing apparatus 16 uses the browser software, or the like, to view various images, such as a layout drawing, that are received from the server device 12 and makes various instructions.

When the instruction that requires the screen change is made in accordance with the user's operation instruction via the input unit 25 after various images, such as a layout drawing, are displayed, the information processing apparatus 16 may send a request to acquire a post-change image to the server device 12 and then display, on the display unit 26, a newly received image. It is desirable to use the following technology. Specifically, it is desirable that the information processing apparatus 16 uses the Ajax (Asynchronous JavaScript (registered trademark)+XML) technology that is the implementation form of an interactive Web application.

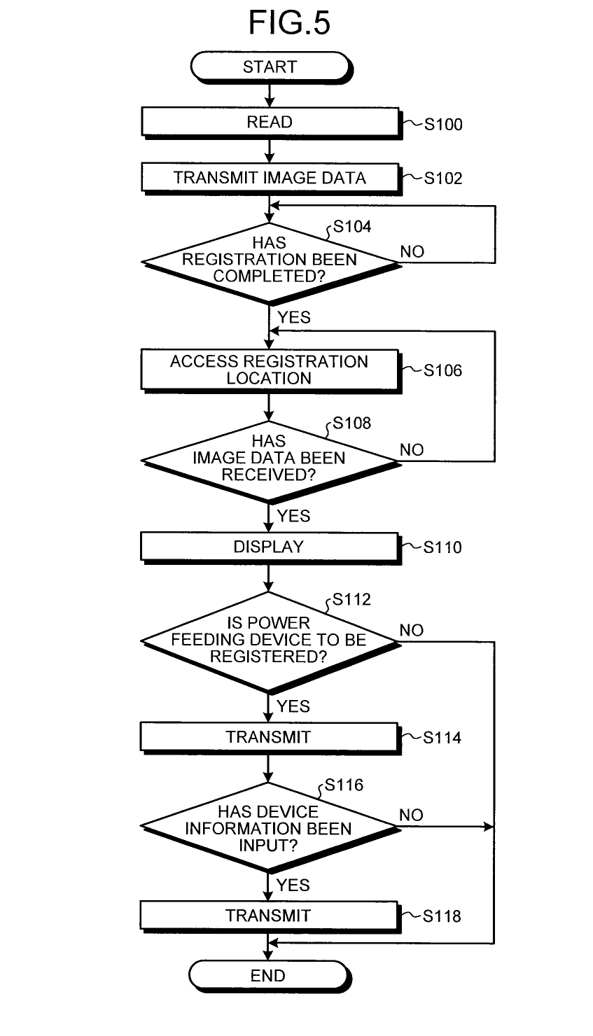

FIG. 5 is a flowchart that illustrates an example of the steps of the information processing performed by the information processing apparatus 16.

First, the control unit 20 reads the original data on the layout drawing (Step S100). For example, the user acquires the image data on the photograph, map, layout, or the like, of the area where the information processing apparatus 16 or the power feeding device 18 is installed. The control unit 20 then reads the image data. Specifically, if the drive unit 24 of the information processing apparatus 16 has the scanner function, the control unit 20 reads the image on the image data by using the drive unit 24 so as to read the original data on the layout drawing. Furthermore, the original data is read from a storage medium (not illustrated) that is connected to the information processing apparatus 16 so that the original data on the layout drawing is read.

Next, the communication unit 28 transmits, to the server device 12, the image data that is the original data on the layout drawing that is read at Step S100 (Step S102). The communication unit 28 then determines whether the layout drawing has been registered in the server device 12 (Step S104). At Step S104, it is determined whether the address information (e.g., URL) that indicates the storage location of the layout drawing has been received from the server device 12, whereby a determination is made at Step S104.

The communication unit 28 repeats a negative determination (Step S104: No) until a positive determination is made at Step S104 (Step S104: Yes). When a positive determination is made (Step S104: Yes), the process proceeds to Step S106.

At Step S106, the control unit 20 accesses the registration location of the layout drawing (Step S106). At Step S106, the control unit 20 accesses the URL that is indicated by the address information received at Step S104 so as to access the registration location of the layout drawing in the server device 12. By the operation at Step S106, the image data on the layout drawing is transmitted from the server device 12.

The communication unit 28 then determines whether the image data on the layout drawing has been received that is registered in the registration location that has been accessed at Step S106 (Step S108). When a negative determination is made at Step S108 (Step S108: No), the process returns to the above-described Step S106. Conversely, when a positive determination is made at Step S108 (Step S108: Yes), the process proceeds to Step S110.

At Step S110, the layout drawing on the image data received at Step S108 is displayed on the display unit 26 (Step S110).

Next, the control unit 20 determines whether the power feeding device 18 is to be registered (Step S112). A determination at Step S112 is made by determining whether the power feeding device 18 to be located on the layout drawing has been designated in accordance with the user's operation instruction via the input unit 25. Specifically, the user operates the input unit 25 so as to designate (point or click) a desired position on the layout drawing displayed on the display unit 26. Thus, the input unit 25 inputs, to the control unit 20, the position (the first position) of the newly registered power feeding device 18 on the layout drawing and the information that indicates the power feeding device 18. The control unit 20 may make a determination at Step S112 by determining whether the above information has been received from the input unit 25.

When a negative determination is made at Step S112 (Step S112: No), the present routine is terminated. Conversely, when a positive determination is made at Step S112 (Step S112: Yes), the process proceeds to Step S114.

At Step S114, the communication unit 28 transmits, to the server device 12, the information that indicates the first position of the power feeding device 18 that is an object to be registered, the first position having been input at Step S112, and the instruction to register the power feeding device 18 (Step S114).

Next, the control unit 20 determines whether the device information has been input from the input unit 25 (Step S116). The control unit 20 determines whether the device information on the information processing apparatus 16 or the power feeding device 18 has been input from the input unit 25 in accordance with the user's operation instruction via the input unit 25, thereby making a determination at Step S116. The device information is the information that indicates the information processing apparatus 16 or the power feeding device 18. Specifically, the device information includes the owner of the information processing apparatus 16 or the power feeding device 18, the type of information processing apparatus 16 or power feeding device 18, or the like.

When a negative determination is made at Step S116 (Step S116: No), the present routine is terminated. When a positive determination is made at Step S116 (Step S116: Yes), the process proceeds to Step S118. At Step S118, the device information input at Step S116 is transmitted to the server device 12 (Step S118). The present routine is then terminated.

Next, an explanation is given of the information processing performed by the power feeding device 18.

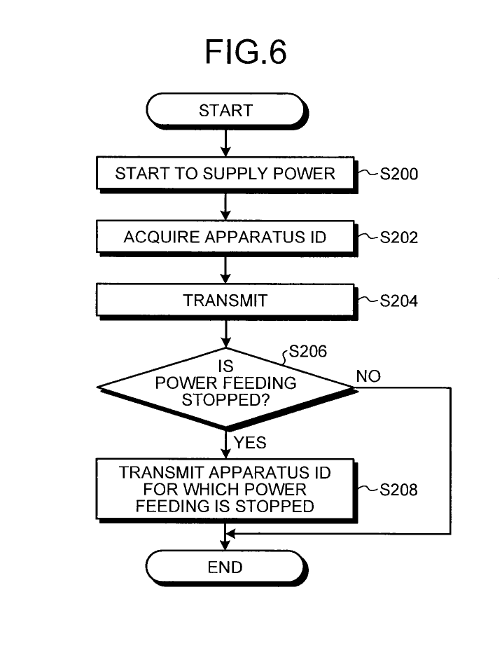

FIG. 6 is a flowchart that illustrates the steps of the information processing performed by the power feeding device 18. When the new information processing apparatus 16 enters the area to which the power feeding device 18 is capable of supplying the electric power or when the power-on switch (not illustrated), or the like, is operated in the information processing apparatus 16 that is installed in the area to which the power feeding device 18 is capable of supplying the electric power, the power feeding device 18 starts to supply the electric power to the information processing apparatus 16 (Step S200).

The control unit 18B then acquires, from the information processing apparatus 16 to which the electric power is being supplied, the apparatus ID (the second identification information) of the information processing apparatus 16 of which the power feeding has started at Step S200 (Step S202). The communication unit 18C then transmits, to the server device 12, the first data that includes the apparatus ID (the second identification information) acquired at Step S202 and the power feeding device ID (the first identification information) of the power feeding device 18 (Step S204).

Next, the control unit 18B determines whether the power feeding is stopped for the information processing apparatus 16 to which the electric power has been supplied (Step S206). When a negative determination is made at Step S206 (Step S206: No), the present routine is terminated. Conversely, when a positive determination is made at Step S206 (Step S206: Yes), the process proceeds to Step S208.

At Step S208, the communication unit 18C transmits, to the server device 12, the apparatus ID of the information processing apparatus 16 for which it is determined that the power feeding is stopped at Step S206 (Step S208). The present routine is then terminated.

Next, an explanation is given of the information processing performed by the server device 12.

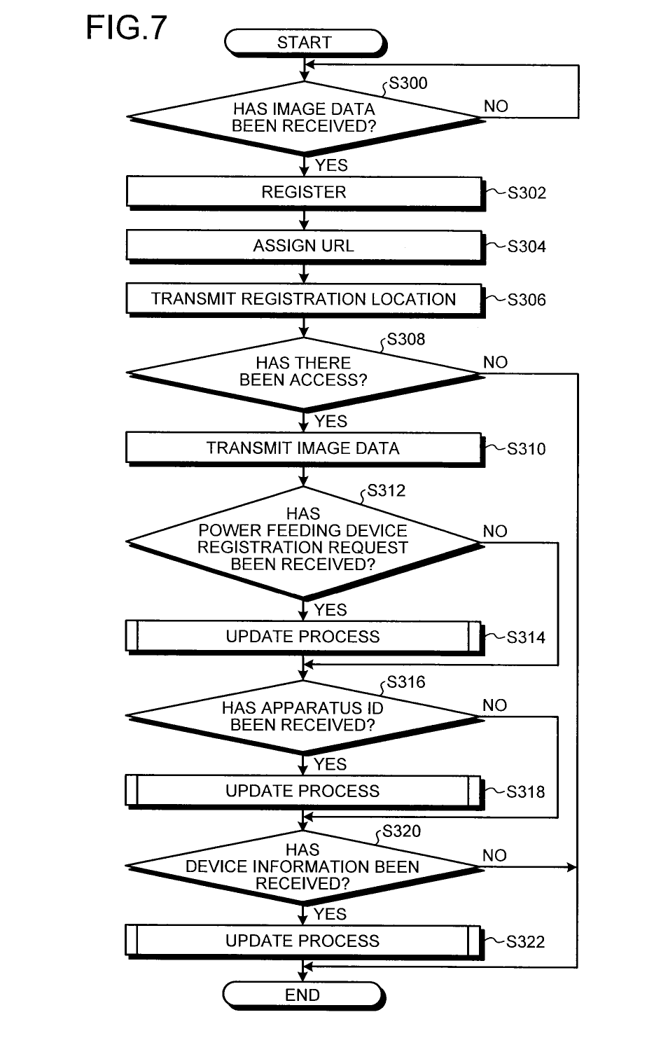

FIG. 7 is a flowchart that illustrates the steps of the information processing performed by the control unit 32 in the server device 12.

First, it is determined whether the acquisition unit 32A has received, from the information processing apparatus 16, the image data that is the original data on the layout drawing (Step S300). At Step S300, a negative determination is repeated (Step S300: No) until a positive determination is made (Step S300: Yes). When a positive determination is made at Step S300 (Step S300: Yes), the process proceeds to Step S302.

At Step S302, the registration unit 32C registers the image data that is the original data on the layout drawing received at Step S300 (Step S302). Specifically, the registration unit 32C first assigns the layout drawing identification information (the layout No.) to the image data that is the original data on the layout drawing received at Step S300 and then stores it in the storage unit 36 in a related manner.

Next, the assignment unit 32B assigns the URL that indicates the address information that is the registration location of the image data stored at Step S302 (Step S304). The transmitting unit 32E then transmits the registration location (Step S306). Specifically, the transmitting unit 32E transmits the address information (URL) assigned at Step S304 to the information processing apparatus 16 that has transmitted the image data at the above-described Step S300.

The receiving unit 32D then determines whether there has been an access (Step S308). At Step S308, the receiving unit 32D determines whether the information processing apparatus 16 has accessed the image data that is stored in the registration location indicated by the address information, thereby making a determination at Step S308.

When a negative determination is made at Step S308 (Step S308: No), the present routine is terminated. Conversely, when a positive determination is made at Step S308 (Step S308: Yes), the process proceeds to Step S310.

At Step S310, the image data on the layout drawing that is stored in the registration location accessed by the information processing apparatus 16 at Step S308 is transmitted to the information processing apparatus 16 (Step S310).

The receiving unit 32D then determines whether the power feeding device registration request has been received from the information processing apparatus 16 (Step S312). A determination at Step S312 is made by determining whether information has been received from the information processing apparatus 16, the information indicating the first position of the power feeding device 18 that is an object to be registered and the instruction to register the power feeding device 18.

When a positive determination is made at Step S312 (Step S312: Yes), the update unit 32F performs the update process to update the layout image by locating the first image of the power feeding device 18 at the first position received at Step S312 (Step S314) (a detailed explanation will be given later). The process then proceeds to Step S316. Conversely, when a negative determination is made at Step S312 (Step S312: No), the process proceeds to Step S316.

At Step S316, the receiving unit 32D determines whether the receiving unit 32D has received the apparatus ID from the power feeding device 18 (Step S316). Specifically, the receiving unit 32D determines whether the receiving unit 32D has received, from the power feeding device 18, the apparatus ID (the second identification information) of the information processing apparatus 16 and the power feeding device ID (the first identification information) of the power feeding device 18, thereby making a determination at Step S316.

When a positive determination is made at Step S316 (Step S316: Yes), the process proceeds to Step S318. At Step S318, the update unit 32F performs the process to update the layout drawing by locating, on the layout drawing, the second image of the information processing apparatus 16 that is identified by the apparatus ID received at Step S316 (Step S318) (a detailed explanation will be given later). The process then proceeds to Step S320. Conversely, when a negative determination is made at the above-described Step S316 (Step S316: No), the process proceeds to Step S320.

At Step S320, it is determined whether the device information has been received from the information processing apparatus 16 (Step S320). When a negative determination is made at Step S320 (Step S320: No), the present routine is terminated. When a positive determination is made at Step S320 (Step S320: Yes), the process proceeds to Step S322. At Step S322, the process to update the layout drawing is performed (Step S322) (a detailed explanation will be given later). The present routine is then terminated.

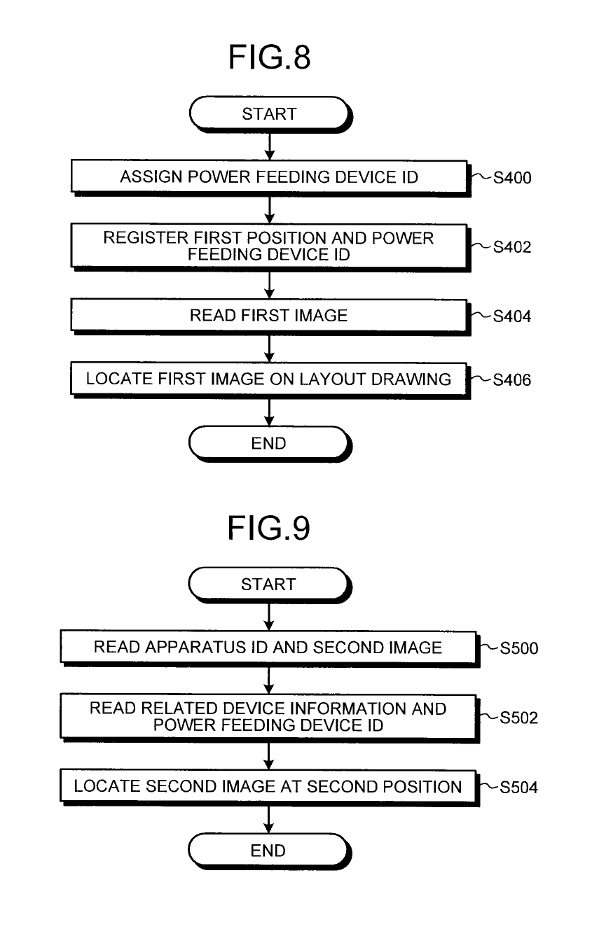

Next, an explanation is given of the steps of the update process performed at the above-described Step S314. FIG. 8 is a flowchart that illustrates the steps of the update process performed at Step S314 that is illustrated in FIG. 7.

First, the assignment unit 32B assigns the power feeding device ID to the power feeding device 18 (Step S400). Specifically, the assignment unit 32B reads the first position of the power feeding device 18 that is an object to be registered and the instruction to register the power feeding device 18 that are included in the information on the power feeding device registration request received at the above-described Step S312. The assignment unit 32B then assigns the power feeding device ID as the identification information on the power feeding device 18 that is an object to be registered. The power feeding device ID of the power feeding device 18 may be changed in accordance with the user's operation instruction via an input unit (not illustrated), the editing instruction for the power feeding device ID that is received from the information processing apparatus 16, or the like.

Next, the update unit 32F registers, in the second data, the first position, which is received at the above-described Step S312, of the power feeding device 18 that is an object to be registered and the power feeding device ID assigned at Step S400, the first position of the power feeding device 18 and the power feeding device ID being related to the layout drawing No. of the layout drawing on the image data received at the above-described Step S300 (Step S402).

Next, the update unit 32F reads the first image of the power feeding device 18 from the storage unit 36 (Step S404). The update unit 32F then locates the first image read at Step S404 at the first position registered at the above-described Step S402 on the layout drawing that is related to the layout drawing No. registered at Step S402 (Step S406).

During the operation at Step S406, with respect to the power feeding device 18 that is received as an object to be registered from the information processing apparatus 16, the update unit 32F locates the first image of the power feeding device 18 at the first position, which is received from the information processing apparatus 16, on the layout drawing, thereby updating the layout drawing.

The present routine is then terminated.

Next, an explanation is given of the update process performed at the above-described Step S318 and Step S322. FIG. 9 is a flowchart that illustrates the steps of the update process performed at Step S318 and Step S322 that are illustrated in FIG. 7.

First, the update unit 32F reads the apparatus ID that is received from the power feeding device 18 at Step S316 and the second image of the information processing apparatus 16 (Step S500). The update unit 32F then reads, from the storage unit 36, the power feeding device ID and the device information that are related to the apparatus ID read at Step S500 (Step S502). The update unit 32F acquires, from the third data in the storage unit 36, the power feeding device ID and the device information (e.g., the owner, type, or operation status) that are related to the apparatus ID read at Step S500, thereby performing the operation at Step S502. Furthermore, the update unit 32F reads the second image of the information processing apparatus 16 from the storage unit 36. The update unit 32F may read, from the storage unit 36, the second image that is related to the type of information processing apparatus 16 that is acquired from the third data.

Next, the update unit 32F locates the second image of the information processing apparatus 16 read at the above-described Step S502 at the second position on the layout drawing that is related to the layout drawing No. registered at the above-described Step S402, the second position being within a predetermined area of the first position of the power feeding device 18 that is identified by the power feeding device ID read at Step S502 (Step S504). During the operation at Step S504, the update unit 32F updates the layout drawing.

The storage unit 36 previously stores the area (distance) to which the power feeding device 18 is capable of feeding the electric power. The update unit 32F may define the area to which the power feeding device 18 is capable of feeding the electric power by using the second position within a predetermined area of the first position of the power feeding device 18.

The present routine is then terminated.

If the related device information and the second image are not stored in the storage unit 36 during the operation at the above-described Step S502, a request to acquire the device information and the second image may be transmitted to the information processing apparatus 16. When receiving the acquisition request, the information processing apparatus 16 displays, on the display unit 26, the information to prompt the user to input the device information and the second image. When the device information and the second image are input in accordance with the user's operation instruction via the input unit 25, the information processing apparatus 16 may transmit the input device information and second image to the server device 12. The server device 12 may store the received device information and second image in the storage unit 36.

Next, an explanation is given of the display process performed by the server device 12 when the user views the layout drawing in the information processing apparatus 16.

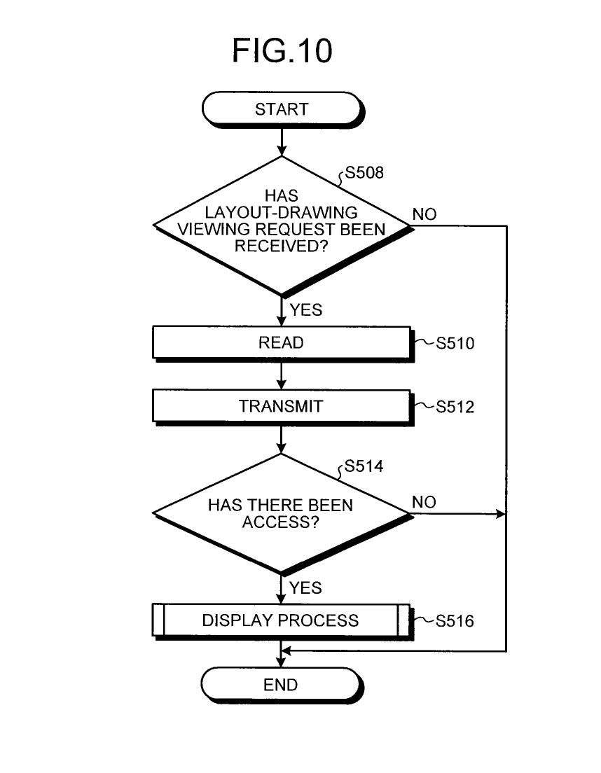

FIG. 10 is a flowchart that illustrates the steps of the display process performed by the server device 12. The receiving unit 32D of the server device 12 determines whether a layout-drawing viewing request has been received from the information processing apparatus 16 (Step S508). The layout-drawing viewing request includes the apparatus ID of the information processing apparatus 16 and the instruction signal that indicates the layout-drawing viewing request.

When a negative determination is made at Step S508 (Step S508: No), the present routine is terminated. When a positive determination is made at Step S508 (Step S508: Yes), the process proceeds to Step S510.

At Step S510, the transmitting unit 32E reads the layout drawing (Step S510). Specifically, at Step S510, the transmitting unit 32E reads, from the third data in the storage unit 36, the power feeding device ID that is related to the apparatus ID included in the layout-drawing viewing request received at Step S508. The transmitting unit 32E then reads, from the second data in the storage unit 36, the layout drawing No. that is related to the read power feeding device ID and reads, from the storage unit 36, the layout drawing that is related to the layout drawing No., thereby performing the operation at Step S510.

Next, the transmitting unit 32E transmits the address information (URL) that indicates the storage location, in the storage unit 36, of the layout drawing read at Step S510 to the information processing apparatus 16 that has transmitted the layout-drawing viewing request at Step S508 (Step S512).

Next, at Step S514, it is determined whether there has been an access to the address information from the information processing apparatus 16 to which the address information has been transmitted at the above-described Step S512 (Step S514). When a negative determination is made at Step S514 (Step S514: No), the present routine is terminated. Conversely, when a positive determination is made at Step S514 (Step S514: Yes), the process proceeds to Step S516.

At Step S516, the process to display the layout drawing is performed (Step S516). The operation at Step S516 is performed in the same manner as that at Steps S310 to S322 illustrated in FIG. 7. The present routine is then terminated.

As described above, in the server device 12 according to the present embodiment, the receiving unit 32D receives, from the power feeding device 18, the first data that includes the first identification information (the power feeding device ID) on the power feeding device 18 and the second identification information (the apparatus ID) on the information processing apparatus 16 to which the power feeding device 18 feeds the electric power. The storage unit 36 stores, in a related manner, the first identification information on the power feeding device 18, the layout drawing in which the first image indicating the power feeding device 18 identified by the first identification information is located at the first position that corresponds to the positional information in the real space, and the first position. The update unit 32F updates the layout drawing by locating the second image at the second position on the layout drawing, the second image indicating the information processing apparatus 16 that is identified by the second identification information included in the first data that is received by the receiving unit 32D, and the second position being within a predetermined area of the first position of the power feeding device 18 identified by the first identification information included in the first data. At least when the layout drawing is updated, the transmitting unit 32E transmits the layout drawing to the information processing apparatus 16.

Thus, in the server device 12 according to the present embodiment, it is possible to visually provide the position of the information processing apparatus 16 connected to the network in real time even from remote locations.

Next, a detailed explanation is given of an example of an image, such as a layout drawing, that is displayed on the display unit 26 of the information processing apparatus 16 when the above-described information processing is performed by the server device 12, the power feeding device 18, and the information processing apparatus 16 in the information processing system 10.

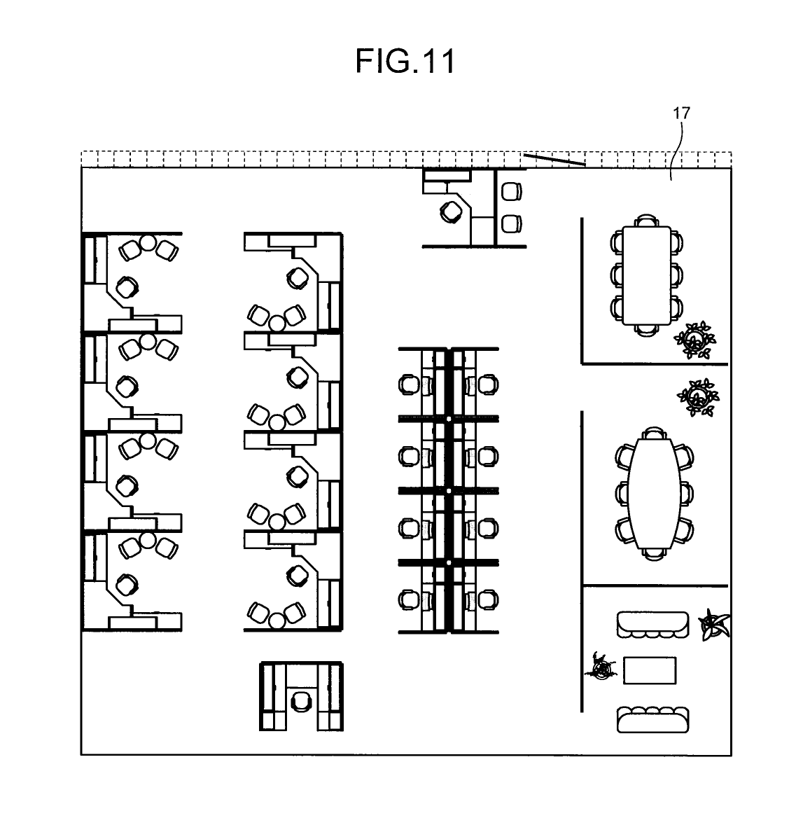

FIGS. 11 to 18 are schematic diagrams that illustrate an example of an image, such as a layout drawing, that is displayed on the display unit 26 of the information processing apparatus 16. As described above, the image is provided via, for example, a browser.

Specifically, FIG. 11 is a schematic diagram that illustrates an example of the original data on the layout drawing that is transmitted from the information processing apparatus 16 to the server device 12. As illustrated in FIG. 11, for example, the information processing apparatus 16 transmits, to the server device 12, the image data on a layout 17 as the original data on the layout drawing.

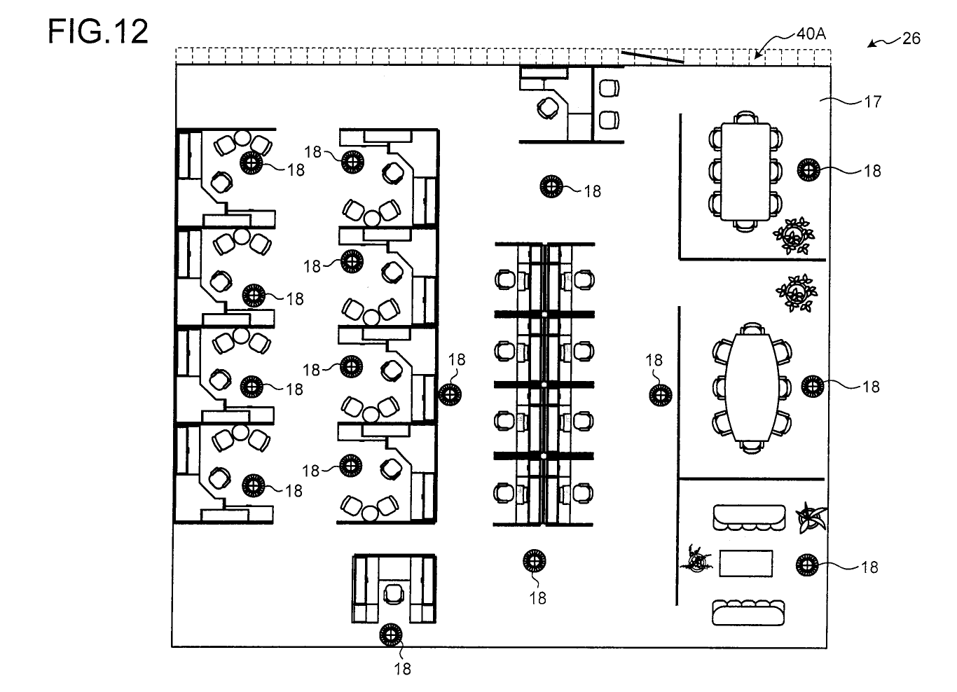

FIG. 12 is a schematic diagram that illustrates a state where the power feeding devices 18 are installed. A position is designated on the layout 17 displayed on the display unit 26 in accordance with the user's operation instruction via the input unit 25 so that the first position of the power feeding device 18 is designated. The display unit 26 displays a layout drawing 40A that is illustrated in FIG. 12.

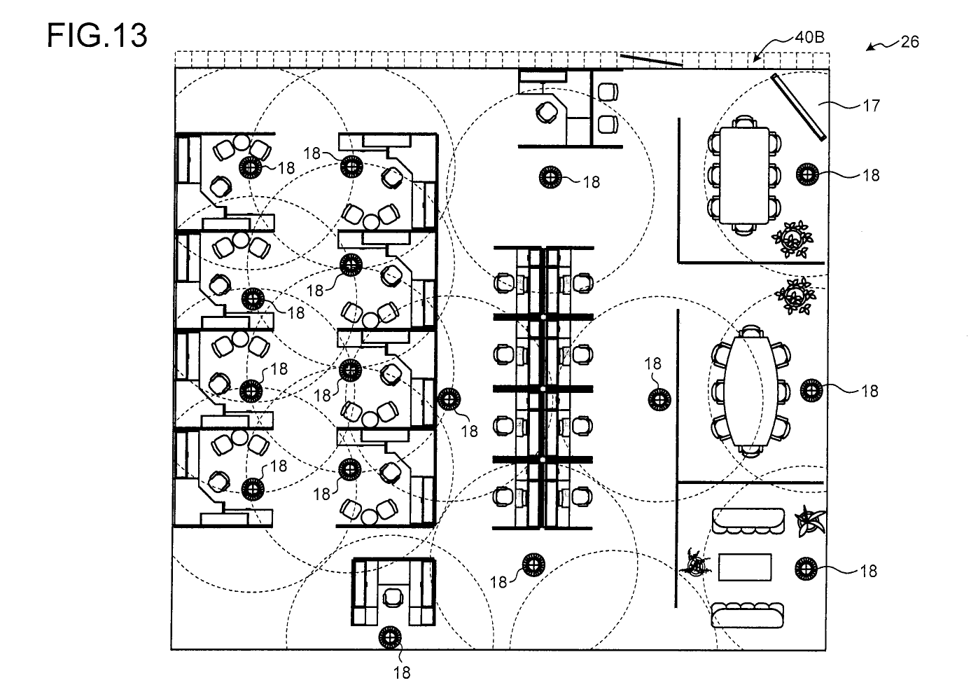

FIG. 13 is a schematic diagram that illustrates an example of each of the areas to which the power feeding devices 18 is capable of supplying the electric power. The area indicated by the dotted line in FIG. 13 with the first position of the power feeding device 18 at the center is the area to which the power feeding devices 18 is capable of supplying the electric power. Thus, a layout drawing 40B may include the image (the dotted line in FIG. 13) that indicates the area to which the power feeding device 18 is capable of feeding the electric power. The region where the power-feeding possible area indicated by the dotted line overlaps another power-feeding possible area is the region to which the electric power can be fed by the multiple power feeding devices 18. Therefore, the apparatus ID of the information processing apparatus 16 that is located at the overlap region is acquired by the multiple power feeding devices 18; thus, the more accurate position (the second position) is applied to the layout drawing.

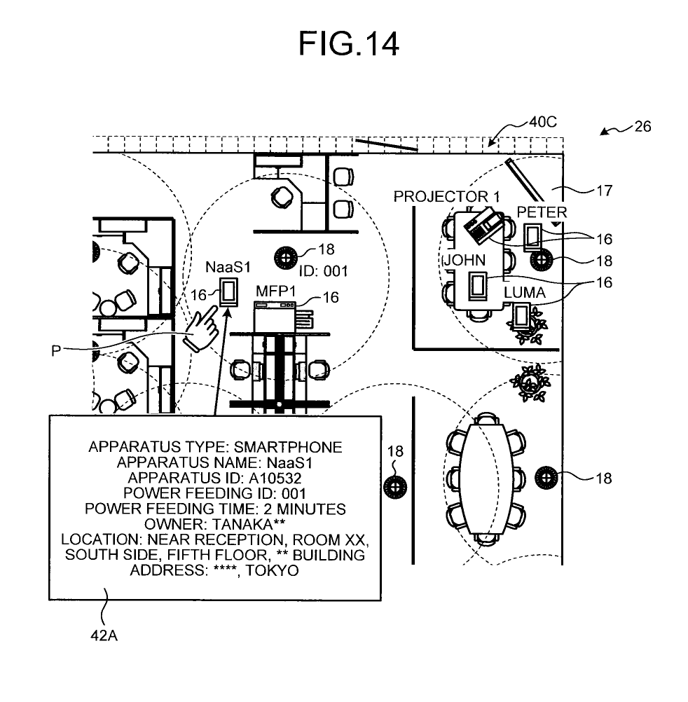

FIGS. 14 to 16 are schematic diagrams that illustrate an example of a layout drawing 40C that is generated by the server device 12 and that illustrates a state where the layout drawing 40C is displayed on the display unit 26 of the information processing apparatus 16.

As illustrated in FIG. 14, the layout drawing 40C is a drawing in which the first image of the power feeding device 18 is located at the first position and the second image of the information processing apparatus 16 is located at the second position. Furthermore, as illustrated in FIG. 14, the layout drawing 40C may include the power feeding device ID of each of the power feeding devices 18 or the device information, such as the apparatus ID or owner, of each of the information processing apparatuses 16. Moreover, the device information on each of the information processing apparatuses 16 may be displayed on the display unit 26 when a pop-up screen 42A is displayed, the pop-up screen 42A being displayed when the position of a pointer P points any of the display locations of the second images of the information processing apparatuses 16 on the screen of the display unit 26 in accordance with the user's operation instruction via the input unit 25.

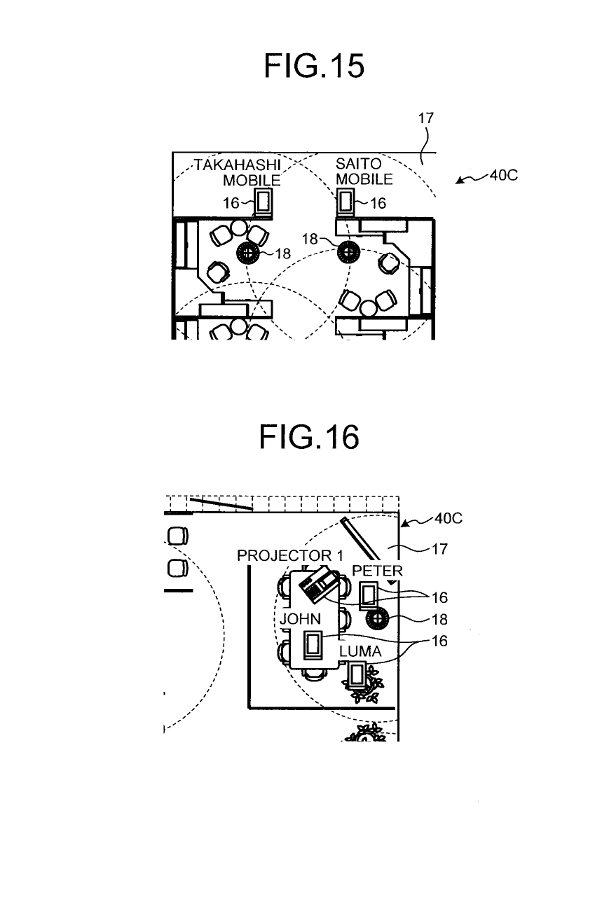

Furthermore, the layout drawing 40C may illustrate the second image by using a color that corresponds to the operation status of the information processing apparatus 16 or may indicate the device information by using the textual information that has a color corresponding to the operation status. For example, as illustrated in FIGS. 15 and 16, the second image of the information processing apparatus 16 that is not in operation may be illustrated by using the color that indicates “not in operation”.

Furthermore, the information, such as the owner, type, or the like, of each of the information processing apparatuses 16 is displayed near the second image of the information processing apparatus 16. Moreover, the second image is illustrated by using the color that corresponds to the operation status of the information processing apparatus 16. Thus, the layout drawing 40C is provided to the information processing apparatus 16 and is displayed on the display unit 26 of the information processing apparatus 16 so that the user is able to accurately understand the type of information processing apparatus 16 that is in operation and the position of each of the information processing apparatuses 16.

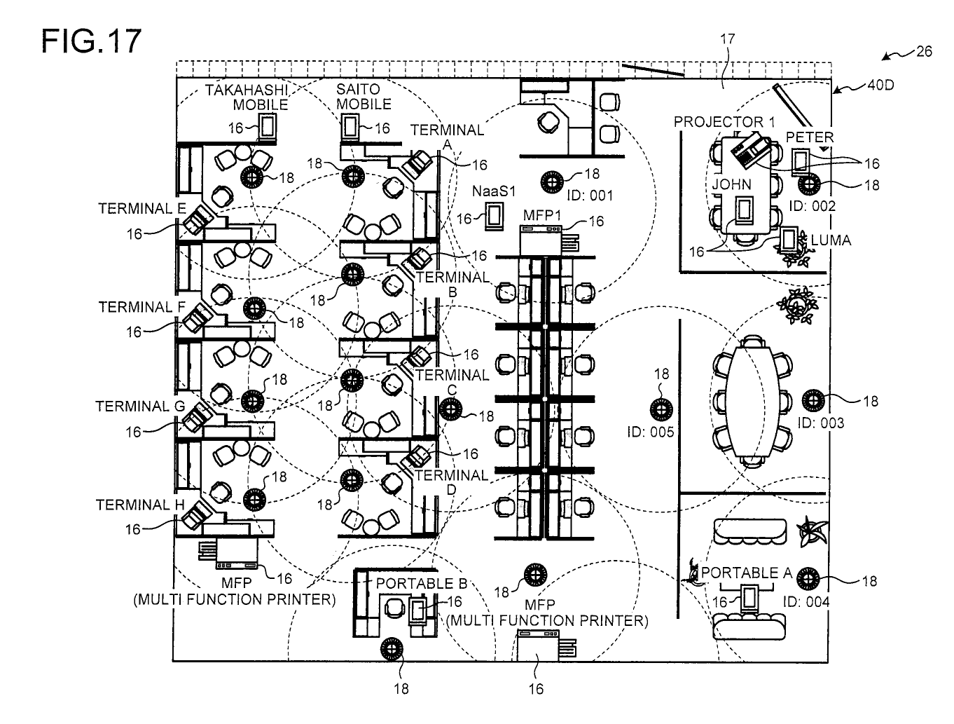

FIG. 17 is a schematic diagram that illustrates an example of a layout drawing 40D.

As illustrated in FIG. 17, the layout drawing 40D generated by the server device 12 is the image in which the first image indicating the power feeding device 18 is located at the first position and the second image indicating the information processing apparatus 16 is located at the second position, the power feeding device 18 being capable of feeding the electric power to the information processing apparatus 16. Thus, the layout drawing 40D is provided to the information processing apparatus 16 so that the user who operates the information processing apparatus 16 is able to visually and instantly check the position of the information processing apparatus 16 at a desired area from a remote location, or the like, in real time.

Furthermore, the second image of each of the information processing apparatuses 16 is displayed by using a display form, such as a color that corresponds to the operation status of each of the information processing apparatuses 16 so that it is possible to easily provide the user who operates the information processing apparatus 16 with the operation status of each of the information processing apparatuses 16.

Moreover, when the first image on the layout drawing 40D displayed on the display unit 26 is designated in accordance with the user's operation instruction via the input unit 25, the details, such as the device information, of the information processing apparatus 16 of the designated first image are displayed. Thus, it is possible to easily provide the user who operates the information processing apparatus 16 with the detailed device information on each of the information processing apparatuses 16. Furthermore, the displayed device information may be edited in accordance with the user's operation instruction via the input unit 25.

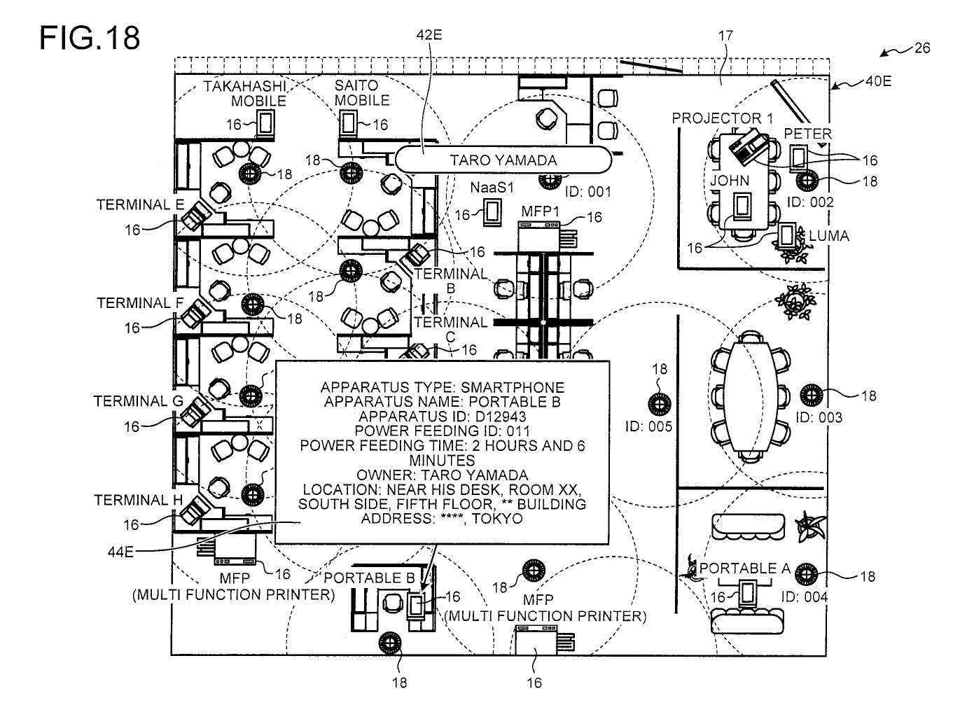

Assume that a keyword, such as the information processing apparatus 16 that is an object to be searched, the owner, or the like, is input in accordance with the user's operation instruction via the input unit 25 in the information processing apparatus 16. For example, assume that, as illustrated in FIG. 18, “Taro Yamada” that is an object to be searched is input to a search window 42E.

In this case, the keyword that is an object to be searched is transmitted from the information processing apparatus 16 to the server device 12. When receiving the keyword, the server device 12 searches for the device information on the information processing apparatus 16 that is related to the keyword in the storage unit 36 and then transmits the search result to the information processing apparatus 16. When receiving the search result, the information processing apparatus 16 displays the search result on, for example, the window 44E, as illustrated in FIG. 18. Thus, it is possible to easily provide the position and the device information on the information processing apparatus 16 that is desired by the user.

The server device 12 according to the present embodiment has the hardware configuration that uses a typical computer.

The program for performing the above-described information processing executed by the server device 12 according to the present embodiment is provided by being stored, in the form of a file that is installable or executable, in a recording medium readable by a computer, such as a CD-ROM, flexible disk (FD), CD-R, or digital versatile disk (DVD).

Furthermore, a configuration may be such that the program for performing the information processing executed by the server device 12 according to the present embodiment is stored in a computer connected via a network such as the Internet and provided by being downloaded via the network. Moreover, a configuration may be such that the program for performing the information processing executed by the server device 12 according to the present embodiment is provided or distributed via a network such as the Internet.

Moreover, a configuration may be such that the program for performing the information processing executed by the server device 12 according to the present embodiment is provided such that it is installed in a ROM, or the like, in advance.

The server device 12 according to the present embodiment has a modular configuration that includes the functional unit for performing the above-described information processing. In terms of actual hardware, a CPU (processor) reads the program for performing the information processing from a storage medium and executes the read program, whereby each of the above-described functional units is loaded into a main storage device and is generated in the main storage device.

According to an aspect of the present embodiment, it is possible to visually provide the position of a network-connected information processing apparatus in real time.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server device comprising:
a storage unit that stores first identification information on a power feeding device and that stores a layout drawing that has a first image located at a first position, the power feeding device being connected to the server device via a network and feeding electric power to an information processing apparatus that is connected to the server device via a network, the first image indicating the power feeding device that is identified by the first identification information, and the first position corresponding to positional information in a real space;
a receiving unit that receives, from the power feeding device, first data that includes the first identification information on the power feeding device and that includes second identification information on the information processing apparatus that has its electric power fed by the power feeding device;
an update unit that updates the layout drawing by locating a second image at a second position on the layout drawing, the second image indicating the information processing apparatus that is identified by the second identification information included in the received first data, and the second position being within a predetermined area of the first position of the power feeding device that is identified by the first identification information included in the first data, and
a transmitting unit that transmits the layout drawing to the information processing apparatus at least when the layout drawing is updated.

2. The server device according to claim 1, wherein the receiving unit receives, from the power feeding device, the first data that includes the first identification information on the power feeding device and the second identification information on the information processing apparatus to which the power feeding device has started to feed electric power.

3. The server device according to claim 1, wherein
the storage unit further stores, in a related manner, the second identification information, the first identification information on the power feeding device that feeds electric power to the information processing apparatus identified by the second identification information, and device information about the information processing apparatus identified by the second identification information, and
the update unit updates the layout drawing by locating the second image at the second position on the layout drawing, the second image including the device information that is related to the second identification information.

4. The server device according to claim 3, wherein the device information includes at least one of an operation status of the information processing apparatus identified by the second identification information, a type of the information processing apparatus, and an owner of the information processing apparatus.

5. An information processing method performed by a server device, the information processing method comprising:
receiving, from a power feeding device, first data that includes first identification information on the power feeding device and that includes second identification information on an information processing apparatus that has its electric power fed by the power feeding device, the power feeding device being connected to the server device via a network and feeding electric power to the information processing apparatus that is connected to the server device via a network,
updating a layout drawing that is stored in a storage unit, the storage unit storing, in a related manner, the first identification information and the layout drawing that has a first image located at a first position, the first image indicating the power feeding device that is identified by the first identification information, the first position corresponding to positional information in a real space, the layout drawing being updated by locating a second image at a second position on the layout drawing, the second image indicating the information processing apparatus that is identified by the second identification information included in the received first data, and the second position being within a predetermined area of the first position of the power feeding device that is identified by the first identification information included in the first data; and
transmitting the layout drawing to the information processing apparatus at least when the layout drawing is updated.

6. A computer program product comprising a non-transitory computer-readable medium having computer readable program codes, performed by a server device, the program codes when executed causing the server device to execute:
receiving, from a power feeding device, first data that includes first identification information on the power feeding device and that includes second identification information on an information processing apparatus that has its electric power fed by the power feeding device, the power feeding device being connected to the server device via a network and feeding electric power to the information processing apparatus that is connected to the server device via a network,
updating a layout drawing that is stored in a storage unit, the storage unit storing, in a related manner, the first identification information and the layout drawing that has a first image located at a first position, the first image indicating the power feeding device that is identified by the first identification information, the first position corresponding to positional information in a real space, the layout drawing being updated by locating a second image at a second position on the layout drawing, the second image indicating the information processing apparatus that is identified by the second identification information included in the received first data, and the second position being within a predetermined area of the first position of the power feeding device that is identified by the first identification information included in the first data; and
transmitting the layout drawing to the information processing apparatus at least when the layout drawing is updated.
